(19) United States
(12) Patent Application Publication
(10) Pub. No.: US 2014/0268490 A1
(43) Pub. Date: Sep. 18, 2014

(54) Super Capacitor And Method For Manufacturing The Same

(71) Applicant: National Taiwan University, (US)

(72) Inventors: Feng-Yu Tsai, Taipei City (TW); Ming-Hong Tseng, Taichung City (TW)

(73) Assignee: National Taiwan University, Taipei (TW)

(21) Appl. No.: 13/861,546

(22) Filed: Apr. 12, 2013

(30) Foreign Application Priority Data
Mar. 12, 2013 (TW) 102108617

(51) Int. Cl. H01G 4/01; H01G 11/26; H01G 4/008

(52) U.S. Cl. CPC H01G 4/01; H01G 4/008; H01G 11/26; Y10S 977/948; B82Y 99/00
USPC 361/305; 361/303; 427/79; 427/532; 977/948; 977/891

(57) ABSTRACT

The invention provides a super capacitor, comprising: a bottom electrode, made of metal that has a sponge-like porous bicontinuous structure wherein the porous bicontinuous structure comprises a plurality of continuous nano pores; a dielectric layer, made of material with high dielectric constant and disposed on the bottom electrode wherein the dielectric layer has a thickness of 0.5˜15 nm; and a top electrode, comprising single layer or multiple layers of conductive layers and having a thickness more than 10 nm.

### BACKGROUND OF THE INVENTION

1. Field of the Invention

The present invention is generally related to a super capacitor, and more particularly to a super capacitor having a sponge-like electrode structure.

2. Description of the Prior Art

Super capacitors can be used in various applications, especially for those require an energy storage device, including electric brakes for mobile, electric power storage for electric mobile, electric power recovery during car braking, electric power storage for fuel and solar cells, filtering and electric power storage for power source electric circuits, uninterrupted power supply, etc.

Based on working principle, super capacitors are divided into two types: (1) solid-state capacitors having a metal-insulator-metal (MIM; metal layer/dielectric layer/metal layer) layer structure and (2) electrochemical capacitors storing electric energy by utilizing redox reaction. Solid-state capacitors have more potential than electrochemical capacitors since they have merits of fast charging speed, being applicable to high-frequency electric circuits, being capable to integrate into semiconductor processes. The capacitance of a solid-state capacitor is determined by total surface area and capacitance of the dielectric layer where it is proportional to the dielectric constant of the dielectric layer and inversely proportional to the thickness of the dielectric layer. Therefore, in order to reach super capacitance, a solid-state capacitor should have extremely large electrode surface area, extremely high dielectric constant of the dielectric layer and extremely thin dielectric layer.

In the patent application No. TW100147652, nanoporous gold (NPG) formed by selectively etching gold-silver alloy and a template technique accompanied with solution replacement reaction are disclosed to deposit ceramic MnO₂ or SiO₂ on surfaces of the core (NPG) metal to obtain core-shell type nanoporous metal composite (nanoporous gold core and ceramic deposited shell type nanostructure composite). Similarly, fabricating 3D (three-dimensional) NPG as a supporter and depositing ceramic (SnO₂) on the support can be performed to obtain NPG/SnO₂ nanocomposite that is found to be applied as an anode material for a lithium ion batteries.

Moreover, in the patent application No. TW100101979, a planar ultracapacitor comprising a substrate, a carbon nanotube film and a transition metal oxide layer is disclosed. The carbon nanotube film with a fork-type pattern is deposited on the substrate and the transition metal oxide layer with the same fork-type pattern is deposited on the carbon nanotube film. In one embodiment of one prior art, the material of the transition metal oxide layer includes manganous oxide, manganese molybdenum oxide, nickel cobalt oxide, cobalt oxide, lead oxide or any combination thereof and the transition metal oxide layer is only plated on the anode or plated both on the anode and the cathode. The carbon nanotube film includes a plurality of carbon nanotubes that are aligned perpendicular to the substrate.

In another patent application No. 093135904, a surface modification technique of improving the porous structure of a surface of a porous carbon material to enhance the electric properties of an ultracapacitor is disclosed. Nano-porous fibers grow on the surface of the carbon material by vapor deposition, thereby the proportion of mesopores of the modified carbon material is increased, and the diffusion rate of ions thereof is increased. The electrochemical characteristics of an ultracapacitor are enhanced, when the surface modified carbon material is used as the electrode material of the ultracapacitor.

U.S. Pat. No. 7,084,002 discloses a method for manufacturing a nano-structured metal oxide electrode comprising: (i) preparing an alumina or polymer template having a plurality of nano-sized pores; (ii) sputtering a metal acting as a current collector having a thickness of a few tens of μm in one surface of said alumina or polymer template; (iii) contacting the alumina or polymeric template having a current collector deposited thereon with a precipitation solution having a metal salt dissolved therein, and applying a current or electrode electric potential; (iv) electrochemically precipitating a metal oxide in the nano-sized pores of said alumina or polymeric template; (v) contacting said nano-structure metal oxide composite of the alumina or polymer template and the precipitated metal oxide with a sodium hydroxide solution under conditions conducive to removing the alumina or polymeric template; and (vi) drying said nano-sized metal oxide to provide the nano-structured metal oxide electrode. The current collector metal sputtered with a thickness of between about 550 μm and the current collector metal has an excellent electrical conductivity, is stable during an electrochemical precipitation of the metal oxide, and is chemically and electrochemically stable in the presence of the metal salt solution. The metal salt dissolved in the precipitation solution contains nickel. The current has a current density of about 10-250 mA/cm² or electrode electric potential is between about 10-250 mV. The nano-structured composite of the alumina or polymer template is contacted with a sodium hydroxide solution having a concentration of about 0.1 M to about 5 M for between about 10 to 60 minutes.

In the specification of US patent application No. 2011/0073827, an anodic aluminum oxide (AAO) nanoporous structure as a substrate of a solid-state capacitor is disclosed. However, the surface of AAO is non-conductive and a conductive layer (or film) should be coated on surfaces of AAO to be used as a bottom electrode. Besides, AAO has a nano-structure but the specific surface area is not large enough and coating a conductive layer may result in reduction of its specific surface area. AAO also has a problem of making on a large substrate and it is difficult in mass production.

According to the above prior arts, the technique of solid-state capacitors currently is still limited by the following issues: (1) difficulty in preparing a bottom electrode with a large surface area; (2) difficulty in depositing a uniform, perfectly covered and very thin dielectric layer on the bottom electrode with a large surface area; and (3) difficulty in depositing a uniform top electrode layer with excellent conductivity on the dielectric layer.

### SUMMARY OF THE INVENTION

In light of the above background, in order to fulfill the requirements of industries, one object of the present invention is to provide a super capacitor and method for manufacturing the same directly using a nanoporous metallic structure as a bottom electrode without coating an additional conductive film where the bottom electrode has a sponge-like porous bicontinuous structure having a surface area much larger than that of the AAO porous structure. Thus, capacitance can be dramatically increased and the alloy used in the present invention can be prepared by traditional metallurgy and the de-alloying process is a simple solution process so that the present invention is advantageous in large area and mass production.

One object of the present invention is to use an alloy substrate to form a porous metallic substrate with a high surface area by a de-alloying process where the porous metallic substrate with a high surface area can be used as a bottom electrode layer of a capacitor. The present invention uses an atomic layer deposition (ALD) technique or other metal oxidation methods to form oxide films with high dielectric constant on surfaces of the porous metal, such as the porous metallic substrate with a high surface area. The ALD metal oxidation can form uniform oxide films with high quality on the surfaces of the porous metal and completely cover all surfaces of the porous metal to form a second porous substrate. In addition, the oxide films formed by ALD have high quality and thus only very thin film is required to achieve the purpose of functioning as a dielectric layer so as to significantly increase capacitance of the dielectric layer. The invention uses an atomic layer deposition (ALD) technique to deposit a conductive film on surfaces of the porous dielectric layer of the second porous substrate. Or, melt conductive material is poured into the surfaces of the porous dielectric layer of the second porous substrate. Such a method can precisely completely cover the porous structure with the conductive layer with high conductivity so as to make the capacitor have a maximum capacitance.

In order to achieve the above purposes, one embodiment of the invention provides a super capacitor, comprising: a bottom electrode, made of metal and having a sponge-like porous bicontinuous structure wherein the porous bicontinuous structure comprises a plurality of continuous nano pores; a dielectric layer, made of material with high dielectric constant and disposed on the bottom electrode wherein the dielectric layer has a thickness of 0.5˜15 nm; and a top electrode, comprising single layer or multiple layers of conductive layers and having a thickness more than 10 nm.

In one embodiment, the bottom electrode (metal) having a sponge-like porous bicontinuous structure is formed by using an alloy containing at least two components including active metal and inactive metal and removing the active metal in the alloy via a de-alloying method so as to form the metal having a sponge-like porous bicontinuous structure.

In one embodiment, the alloy is selected from the group consisting of the following: Ag/Au alloy, Zn/Au alloy, Al/Au alloy, Al/Ag alloy, Al/Pd alloy, Al/Cu alloy, Cu/Au alloy, Si/Pd alloy, Cu/Pt alloy, and Mn/Cu alloy. Preferably, the alloy is Al/Ag alloy.

In one embodiment, the nano pores have an average diameter of 50˜120 nm.

In one embodiment, the material with high dielectric constant is selected from the group consisting of the following: aluminum oxide, zirconium oxide, hafnium oxide (Hf₂O₃), and titanium oxide.

In one embodiment, the top electrode is a conductive layer of aluminum doped zinc oxide or indium tin oxide. In another embodiment, the top electrode comprises two conductive layers, a conductive layer of aluminum doped zinc oxide or indium tin oxide and a conductive layer of metal.

In one embodiment, the de-alloying method is to place the alloy in an electrolyte solution and subsequently apply electric current to dissolve the active metal into the solution or to place the alloy in an acidic solution to dissolve the active metal into the solution.

Furthermore, another embodiment of the present invention provides a method for manufacturing a super capacitor, comprising: providing an alloy containing at least two components including active metal and inactive metal; performing a de-alloying procedure to remove the active metal via a de-alloying method to form a metal having a sponge-like porous bicontinuous structure as a bottom electrode wherein the porous bicontinuous structure comprises a plurality of continuous nano pores; performing a dielectric layer deposition procedure to deposit a material with high dielectric constant on surfaces of the bottom electrode by an atomic layer deposition method so as to form a dielectric layer; and performing a top electrode deposition procedure to deposit a single conductive layer or a plurality conductive layers on the dielectric layer so as to form a top electrode.

In one embodiment, the alloy containing at least two components including active metal and inactive metal is formed by co-evaporating two types of metals to form the alloy or by heating and melting two types of metals and then annealing to form the alloy.

In one embodiment, in the above method, in the dielectric layer deposition procedure the atomic layer deposition method is to use trimethyl aluminum and water as precursors at 120˜180° C. to form aluminum oxide film as the dielectric layer.

In one embodiment, in the above method, the top electrode deposition procedure is to use an atomic layer deposition method using aluminum and zinc with an atomic ratio 1:1˜1:50 at 80˜250° C. to form aluminum doped zinc oxide film as the conductive layer.

According to the super capacitor and the method for manufacturing the super capacitor of the present invention, a nanoporous metallic structure is directly used as a bottom electrode without coating an additional conductive film where the bottom electrode has a sponge-like porous bicontinuous structure having a surface area much larger than that of the AAO porous structure. Thus, capacitance can be dramatically increased and the alloy used in the present invention can be prepared by traditional metallurgy and the de-alloying process is a simple solution process so that the present invention is advantageous in large area and mass production.

### BRIEF DESCRIPTION OF THE DRAWINGS

FIG. 1 shows a schematic diagram illustrating a super capacitor according to one embodiment of the present invention where (a) shows a three-dimensional schematic diagram of a bottom electrode having a sponge-like structure and (b) shows a partial cross-sectional schematic diagram of a capacitor;

FIG. 2 shows scanning electron microscope images of a super capacitor comprising a bottom electrode having a sponge-like structure where (a) has magnification of 5000×, (b) has magnification of 30000× and (c) has magnification of 50000×.

### DESCRIPTION OF THE PREFERRED EMBODIMENTS

What is probed into the invention is a super capacitor. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

FIG. 1 shows a schematic diagram illustrating a super capacitor according to one embodiment of the present invention where (a) shows a three-dimensional schematic diagram of a bottom electrode having a sponge-like structure and (b) shows a partial cross-sectional schematic diagram of a capacitor. The super capacitor 100 comprises a bottom electrode 200, a dielectric layer 300 and a top electrode 400. The bottom electrode 200 is formed by metal having a sponge-like porous bicontinuous structure. The so-called metal having a sponge-like porous bicontinuous structure means connected pores (pores are connected) and connected metal (metal is electrically coupled as a whole).

FIG. 2 shows scanning electron microscope images of a super capacitor comprising a bottom electrode having a sponge-like structure where (a) has magnification of 5000×, (b) has magnification of 30000× and (c) has magnification of 50000×. The metal having a sponge-like porous bicontinuous structure as the bottom electrode 200 can be formed by using an alloy containing at least two components including active metal and inactive metal and removing the active metal in the alloy via a de-alloying method so as to form the metal having a sponge-like porous bicontinuous structure. The alloy can be, for example, Ag/Au alloy, Zn/Au alloy, Al/Au alloy, Al/Ag alloy, Al/Pd alloy, Al/Cu alloy, Cu/Au alloy, Si/Pd alloy, Cu/Pt alloy, or Mn/Cu alloy. In the above examples, the former is active metal and the latter is inactive metal, that is, it is shown as “active metal/inactive metal” alloy. Preferably, the alloy is Al/Ag alloy. The thickness of the bottom electrode 200 is, for example, 20˜500 nm. Preferably, it is 50˜120 nm.

The above alloy containing at least two components including active metal and inactive metal is formed by co-evaporating two types of metals to form the alloy or by heating and melting two types of metals and then annealing to form the alloy. Specifically, silver and aluminum with a weight ratio of 1:1/atomic ratio=20:80 are co-evaporated to form the alloy on the substrate. Or, silver and aluminum with a weight ratio of 1:1/atomic ratio=20:80 as an ingot are sealed in vacuum and then melt and annealed to form the alloy.

The above de-alloying method is, for example, to place the alloy in an electrolyte solution and subsequently apply electric current to dissolve the active metal in the solution (electrochemically electrolytic de-alloying) or to place the alloy in an acidic solution to dissolve the active metal in the solution (chemically de-alloying). Specifically, for example when Al/Ag alloy is used, 1% HCl is used to process the alloy at 50° C. for 10 minutes to remove aluminum in the alloy so as to form nanoporous silver. After de-alloying, the remained metal can be washed by water to remove HCl. During practice, the required material and pore size determines which kind of alloy is used. The selection of the acidic solution depends on the pore size. The processing time for de-alloying depends on the processing temperature and the thickness of the alloy. As the processing time increases, a porous structure is gradually formed.

The dielectric layer 300 can be formed by depositing a material having high dielectric constant on surfaces of the bottom electrode and has a thickness of 0.5˜15 nm. Preferably, the thickness of the dielectric layer 300 is 1˜10 nm. If the dielectric layer 300 is too thick, the nano pores of the bottom electrode may be blocked or completely filled to cause the connected pores to become disconnected and cause reduction of capacitance. On the other hand, if the dielectric layer 300 is too thin, the dielectric film may incompletely cover the bottom electrode, that is, some surfaces of the bottom electrode are not covered by the dielectric film to cause short-circuited while subsequent becoming a capacitor. Specifically, for example, formation of the dielectric layer 300 is performed by depositing aluminum oxide as the dielectric layer through ALD deposition at about 150° C. (using trimethyl aluminum and water as precursors) to grow an aluminum oxide film. The precursors can completely infiltrate nanopores by increasing the exposing time (time that the substrate are exposed to precursors) and the degassing time can be prolonged to completely remove the residual precursors and by-products. For example, the exposing time is about 100˜300 seconds and the degassing time is about 100˜300 seconds. More specifically, the exposing time and the degassing time can be separately about 180 seconds. Besides, the thickness of the deposited aluminum oxide is about 5˜10 nm. The material having high dielectric constant can be, for example, aluminum oxide, zirconium oxide, hafnium oxide (Hf₂O₃), or titanium oxide.

The top electrode 400 can be formed by one conductive layer or a plurality of conductive layers. The thickness is about more than 10 nm. Preferably, the thickness of the top electrode 400 is 15˜50 nm. The top electrode 400 can be formed by a conductive layer of aluminum doped zinc oxide or indium tin oxide or by two conductive layers, a conductive layer of aluminum doped zinc oxide or indium tin oxide and a conductive layer of metal. Specifically, formation of the top electrode 400 can be performed by using the ALD deposition method to deposit AZO (aluminum doped zinc oxide) as a conductive film under the conditions of about 150° C., with a Al/Zn atomic ratio of 1:5˜1:50, to form a conductive film (conductive layer) with a thickness of about 20 nm. Similarly, the precursors can completely infiltrate nanopores by increasing the exposing time and the degassing time can be prolonged to completely remove the residual precursors and by-products. Furthermore, on the AZO film, a metal film (such as Cu, Ag, Au, etc.) can be deposited by evaporation to increase conductivity.

According to another embodiment of the present invention, a method for manufacturing a super capacitor is provided. The method comprises the following steps:

Step S10: providing an alloy containing at least two components including active metal and inactive metal;

Step S20: performing a de-alloying procedure to remove the active metal via a de-alloying method to form a metal having a sponge-like porous bicontinuous structure as a bottom electrode wherein the porous bicontinuous structure comprises a plurality of continuous nano pores;

Step S30: performing a dielectric layer deposition procedure to deposit a material with high dielectric constant on surfaces of the bottom electrode by an atomic layer deposition method so as to form a dielectric layer; and

Step S40: performing a top electrode deposition procedure to deposit a single conductive layer or a plurality conductive layers on the dielectric layer so as to form a top electrode.

In step S10, as described in the above, the alloy in use can be obtained by co-evaporation or traditional metallurgy, such as smelting, vacuum smelting, rapid cooling annealing, powder metallurgy, etc.

In step S20, the de-alloying method can be implemented by electrochemically electrolytic de-alloying or chemically de-alloying.

The dielectric layer deposition procedure or the top electrode deposition procedure can use ALD deposition to obtain the dielectric layer or the top electrode.

Furthermore, as the top electrode is formed by a plurality of conductive layer, for example, ALD deposition is performed to form a conductive layer and then evaporation is performed to form a metal layer so as to obtain the top electrode.

The material having high dielectric constant can be, for example, aluminum oxide, zirconium oxide, hafnium oxide (Hf₂O₃), or titanium oxide.

### Example 1

### Preparation of a Capacitor

A gold-plated substrate is used and the substrate is co-evaporated with Al/Ag with an atomic ratio of 80:20 to form Al/Ag alloy thereon. 1% HCl is used to process the Al/Ag alloy at 50° C. for 10 minutes to obtain a sponge-like silver substrate as a bottom electrode. By ALD deposition, an aluminum oxide dielectric layer is deposited on the bottom electrode and its thickness is about 7 nm. Next, on the aluminum oxide dielectric layer, by ALD deposition, aluminum doped zinc oxide as a top electrode is deposited at about 150° C. and its thickness is about 20 nm so as to obtain the capacitor 1 according to the present invention.

The capacitor 1 according to the present invention is compared with a capacitor 2 made by using an AAO substrate and a capacitor 3 made by using regularly aligned carbon nanotubes. The capacitance of the capacitor 1 per unit volume is 1.225 Fcm⁻³ while that of the capacitor 2 is 0.1 Fcm⁻³ and that of the capacitor 3 is 0.023 Fcm⁻³. Thus, it shows that the capacitance of the capacitor 1 per unit volume is significantly increased because the nanoporous metal used in the present invention has the larger surface area per unit volume. Therefore, the capacitance is also increased.

In conclusion, according to the super capacitor and the method for manufacturing the super capacitor of the present invention, a nanoporous metallic structure is directly used as a bottom electrode without coating an additional conductive film where the bottom electrode has a sponge-like porous bicontinuous structure having a surface area much larger than that of the AAO porous structure. Thus, capacitance can be dramatically increased and the alloy used in the present invention can be prepared by traditional metallurgy and the de-alloying process is a simple solution process so that the present invention is advantageous in large area and mass production.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A super capacitor, comprising:
a bottom electrode, made of metal and having a sponge-like porous bicontinuous structure wherein the porous bicontinuous structure comprises a plurality of continuous nano pores;
a dielectric layer, on surfaces of the bottom electrode and formed by a material with high dielectric constant wherein the dielectric layer has a thickness of 0.5˜15 nm; and
a top electrode, comprising a single conductive layer or a plurality of conductive layers wherein the top electrode has a thickness more than 10 nm.

2. The super capacitor according to claim 1, wherein the bottom electrode having a sponge-like porous bicontinuous structure is formed by using an alloy containing at least two components including active metal and inactive metal and removing the active metal in the alloy via a de-alloying method so as to form the bottom electrode having a sponge-like porous bicontinuous structure.

3. The super capacitor according to claim 2, wherein the alloy is selected from the group consisting of the following: Ag/Au alloy, Zn/Au alloy, Al/Au alloy, Al/Ag alloy, Al/Pd alloy, Al/Cu alloy, Cu/Au alloy, Si/Pd alloy, Cu/Pt alloy, and Mn/Cu alloy.

4. The super capacitor according to claim 2, wherein the alloy is Al/Ag alloy.

5. The super capacitor according to claim 1, wherein the nano pores have an average diameter of 50˜120 nm.

6. The super capacitor according to claim 1, wherein the material with high dielectric constant is selected from the group consisting of the following: aluminum oxide, zirconium oxide, hafnium oxide (Hf₂O₃), and titanium oxide.

7. The super capacitor according to claim 1, wherein the top electrode is a conductive layer of aluminum doped zinc oxide or indium tin oxide.

8. The super capacitor according to claim 1, wherein the top electrode comprises two conductive layers, a conductive layer of aluminum doped zinc oxide or indium tin oxide and a conductive layer of metal.

9. The super capacitor according to claim 2, wherein the de-alloying method is to place the alloy in an electrolyte solution and subsequently apply electric current to dissolve the active metal into the solution or to place the alloy in an acidic solution to dissolve the active metal into the solution.

10. A method for manufacturing a super capacitor, comprising:
providing an alloy containing at least two components including active metal and inactive metal;
performing a de-alloying procedure to remove the active metal via a de-alloying method to form a metal having a sponge-like porous bicontinuous structure as a bottom electrode wherein the porous bicontinuous structure comprises a plurality of continuous nano pores;
performing a dielectric layer deposition procedure to deposit a material with high dielectric constant on surfaces of the bottom electrode by an atomic layer deposition method so as to form a dielectric layer; and
performing a top electrode deposition procedure to deposit a single conductive layer or a plurality conductive layers on the dielectric layer so as to form a top electrode.

11. The method according to claim 10, wherein the alloy containing at least two components including active metal and inactive metal is formed by co-evaporating two types of metals to form the alloy or by heating and melting two types of metals and then annealing to form the alloy.

12. The method according to claim 10, wherein the de-alloying method is to place the alloy in an electrolyte solution and subsequently apply electric current to dissolve the active metal into the solution or to place the alloy in an acidic solution to dissolve the active metal into the solution.

13. The method according to claim 10, wherein in the dielectric layer deposition procedure the atomic layer deposition method is to use trimethyl aluminum and water as precursors at 120˜180° C. to form aluminum oxide film as the dielectric layer.

14. The method according to claim 10, wherein the top electrode deposition procedure is to use an atomic layer deposition method using aluminum and zinc with an atomic ratio 1:1˜1:50 at 80˜250° C. to form aluminum doped zinc oxide film as the conductive layer.

15. The method according to claim 10, wherein the alloy is selected from the group consisting of the following: Ag/Au alloy, Zn/Au alloy, Al/Au alloy, Al/Ag alloy, Al/Pd alloy, Al/Cu alloy, Cu/Au alloy, Si/Pd alloy, Cu/Pt alloy, and Mn/Cu alloy.

16. The method according to claim 10, wherein the alloy is Al/Ag alloy.

17. The method according to claim 1, wherein the material with high dielectric constant is selected from the group consisting of the following: aluminum oxide, zirconium oxide, hafnium oxide (Hf₂O₃), and titanium oxide.

18. The method according to claim 10, wherein the nano pores have an average diameter of 50˜120 nm.

19. The method according to claim 10, wherein the top electrode is a conductive layer of aluminum doped zinc oxide or indium tin oxide.

20. The method according to claim 10, wherein the top electrode comprises two conductive layers, a conductive layer of aluminum doped zinc oxide or indium tin oxide and a conductive layer of metal.
